(19) United States
(12) Patent Application Publication
(10) Pub. No.: US 2007/0137417 A1
(43) Pub. Date: Jun. 21, 2007

(54) Handles for attachment to wired products

(76) Inventors: John Richard Nawrocki, Ocala, FL (US); Lee E. Remmers, Ocala, FL (US)

Correspondence Address: Anthony G. Fussner, Suite 400, 7700 Bonhomme, St. Louis, MO, 63105, US

(21) Appl. No.: 11/263,770

(22) Filed: Nov. 1, 2005

(51) Int. Cl. G05G 1/04; G05G 1/10

(52) U.S. Cl. 74/558.5

(57) ABSTRACT

Various aspects of the invention provide handles that can be attached to wire-like members. In one exemplary embodiment, a handle generally includes two handle pieces that can be assembled to one another. When so assembled, the handle pieces cooperatively form a handle body outer surface and a passage therethrough for receiving at least a portion of the wire-like member.

### FIELD

The present invention relates to handles for attachment to wired products.

### BACKGROUND

The statements in this section merely provide background information related to the present disclosure and may not constitute prior art.

Wire baskets or storage bins are commonly used for storing and carrying items. Wire baskets may be constructed to from transversely and longitudinally extending wires (e.g., formed steel wires). Some of the basket's wires may be configured to form wire handles, such as generally U-shaped handles formed by two longitudinally extending wire support members that are configured as a single wire. These wire handles may make it easier for the user to carry the wire basket. But the wire handles can also be a source of discomfort to the user especially when carrying a wire basket loaded with heavy items due to the wire handle pressing into the user's hands.

### SUMMARY

According to various aspects of the invention, there are provided various exemplary embodiments of handles that can be attached to wire-like members, such as wire members of a shelf, basket, bin, sliding tray, etc. In one exemplary embodiment, a handle generally includes at least two handle pieces that can be assembled to one another. When so assembled, the handle pieces cooperatively form a handle body outer surface and a passage therethrough for receiving at least a portion of the wire-like member.

Further aspects and features of the present invention will become apparent from the detailed description provided hereinafter. In addition, any one or more aspects of the invention may be implemented individually or in any combination with any one or more of the other aspects of the invention. It should be understood that the detailed description and specific examples, while indicating exemplary embodiments of the invention, are intended for purposes of illustration only and are not intended to limit the scope of the invention.

### DRAWINGS

The drawings described herein are for illustration purposes only and are not intended to limit the scope of the present disclosure in any way.

FIG. 1 is an exploded perspective view of a two-piece handle that can be attached to a wire according to one exemplary embodiment of the invention;

FIG. 2 is an outer perspective view of one of the handle pieces shown in FIG. 1;

FIG. 3 is an inner perspective view of the handle piece shown in FIG. 2;

FIG. 4 is a partial inner perspective view of the handle piece shown in FIG. 3;

FIG. 5 is a perspective view of the handle shown in FIG. 1 after the handle pieces have been assembled to one another;

FIG. 6 is an exploded perspective view of a two-piece handle that can be attached to a wire according to another exemplary embodiment of the invention;

FIG. 7 is a perspective view of the handle shown in FIG. 6 after the two handle pieces have been assembled to one another;

FIG. 8 is a cross-sectional view of the assembled handle shown in FIG. 7;

FIG. 9 is an exploded perspective view of a two-piece handle that can be attached to a wire according to another exemplary embodiment of the invention;

FIG. 10 is an end view of one of the handle pieces shown in FIG. 9;

FIG. 11 is an inner partial perspective view of the handle piece shown in FIG. 10;

FIG. 12 is a perspective view of the handle shown in FIG. 9 after the two handle pieces have been assembled to one another;

FIG. 13 is an exploded perspective view of a two-piece handle that can be attached to a wire according to another exemplary embodiment of the invention;

FIG. 14 is a perspective view of the handle shown in FIG. 13 after the two handle pieces have been assembled to one another;

FIG. 15 is a side view of the assembled handle shown in FIG. 14;

FIG. 16 is an end view of the assembled handle shown in FIG. 14 with a lower portion removed for clarity;

FIG. 17 is an end view of the assembled handle shown in FIG. 14 with an upper portion removed for clarity;

FIG. 18 is an exploded perspective view of a two-piece handle that can be attached to a wire according to another exemplary embodiment of the invention;

FIG. 19 is a perspective view of the handle shown in FIG. 18 after the two handle pieces have been assembled to one another with a portion removed for clarity;

FIG. 20 is an end view of the handle shown in FIG. 18 after the two handle pieces have been assembled to one another with a portion removed for clarity;

FIG. 21 is a perspective view of one piece of a two-piece handle that can be attached to a wire according to another exemplary embodiment of the invention;

FIG. 22 is a perspective view of the handle piece shown in FIG. 21 after the handle piece has been assembled to a corresponding handle piece with a portion removed for clarity;

FIG. 23 is a cross-sectional view of the assembled handle shown in FIG. 22;

FIG. 24 is an exploded perspective view of a two-piece handle that can be attached to a wire according to another exemplary embodiment of the invention;

FIG. 25 is an inner perspective view of one of the two handle pieces shown in FIG. 24;

FIG. 26 is an inner view of the handle piece shown in FIG. 25;

FIG. 27 is a perspective view of the handle shown in FIG. 24 after the two handle pieces have been assembled to one another;

FIG. 28 is an exploded perspective view of a two-piece handle that can be attached to a wire according to another exemplary embodiment of the invention;

FIG. 29 is a perspective view of the handle shown in FIG. 28 after the two handle pieces have been assembled to one another; and

FIG. 30 is a perspective view of an exemplary wire basket about to be provided with the two-piece handle shown in FIGS. 1 through 5 and the two-piece handle shown in FIGS. 9 through 12 according to another exemplary embodiment of the invention.

### DETAILED DESCRIPTION

The following description is merely exemplary in nature and is in no way intended to limit the present disclosure, application, or uses.

According to various aspects of the invention, there are provided various exemplary embodiments of handles that can be attached to wire-like members, such as wire members of a shelf, basket, bin, sliding tray, etc. In one exemplary embodiment, a handle generally includes at least two handle pieces that can be assembled to one another. When so assembled, the handle pieces cooperatively form a handle body outer surface and a passage therethrough for receiving at least a portion of the wire-like member.

In another exemplary embodiment, a handle generally includes at least two handle pieces. Each handle piece has an outer side, an inner side, at least one portion protruding from the inner side thereof, and at least one recess for engagingly receiving the at least one protruding portion of the other handle piece. At least one protruding portion or recess has at least one catch engageable within at least one opening defined by the corresponding protruding portion or recess, whereby engagement of the catch within the opening inhibits the egress of the protruding portion from within the recess. The handle pieces, when assembled to one another with the protruding portions engaged within the recesses, cooperatively forms a handle body outer surface and a passage therethrough for receiving at least a portion of the wire-like member. The engagement of the protruding portions within the recesses can inhibit relative movement between the handle pieces to thereby attach the handle to the portion of the wire-like member within the passage.

In a further exemplary embodiment, a handle generally includes at least two handle pieces. Each handle piece has an outer side, an inner side, at least one pin protruding from the inner side thereof, and at least one recess for engagingly receiving the at least one pin of the other handle piece. At least one of the pins has a substantially circular transverse profile, and at least one of the recesses has a corresponding substantially circular transverse profile. The handle pieces, when assembled to one another with the pins engaged within the recesses, cooperatively form a handle body outer surface and a passage therethrough for receiving at least a portion of the wire-like member. The engagement of the pins within the recesses can inhibit relative movement between the handle pieces to thereby attach the handle to the portion of the wire-like member within the passage.

In an additional exemplary embodiment, a handle generally includes at least two handle pieces. Each handle piece has an outer side, an inner side, and at least one portion protruding from the inner side thereof. The handle pieces, when assembled to one another, cooperatively form a handle body outer surface and a passage therethrough for receiving at least a portion of the wire-like member. At least some of the protruding portions are configured such that, when the handle pieces are assembled to one another with the wire-like member within the passage, at least one protruding portion of one handle piece is disposed generally about a first side portion of the wire-like member and at least one protruding portion of the other handle piece is disposed generally about a second side portion of the wire-like member generally opposite the first side portion. The protruding portions can cooperatively inhibit relative movement between the handle pieces through contact with the wire-like member.

Other aspects include products (e.g., wire basket, wire ventilated shelves, wire bins, slide-type installation, sliding storage devices, sliding shelves, sliding trays, kitchen cabinetry, garage cabinetry, bathroom cabinetry, pots, pans, buckets, among other devices) having one or more of such handles, methods of using such handles, and methods of making such handles. In addition, any one or more aspects of the invention may be implemented individually or in any combination with any one or more of the other aspects of the invention. For example, one embodiment of the invention may include a wire basket (or other product) having two different handles.

Accordingly, various aspects of the invention relate to handle assemblies and the designs thereof that can be relatively easily, quickly assembled to a wire product without using any tools. Various embodiments of the handle assembly can provide a wire basket (e.g., welded, finished, painted, and/or chrome wire basket, etc.) or other wire products with a higher level of comfort, utility, and identity.

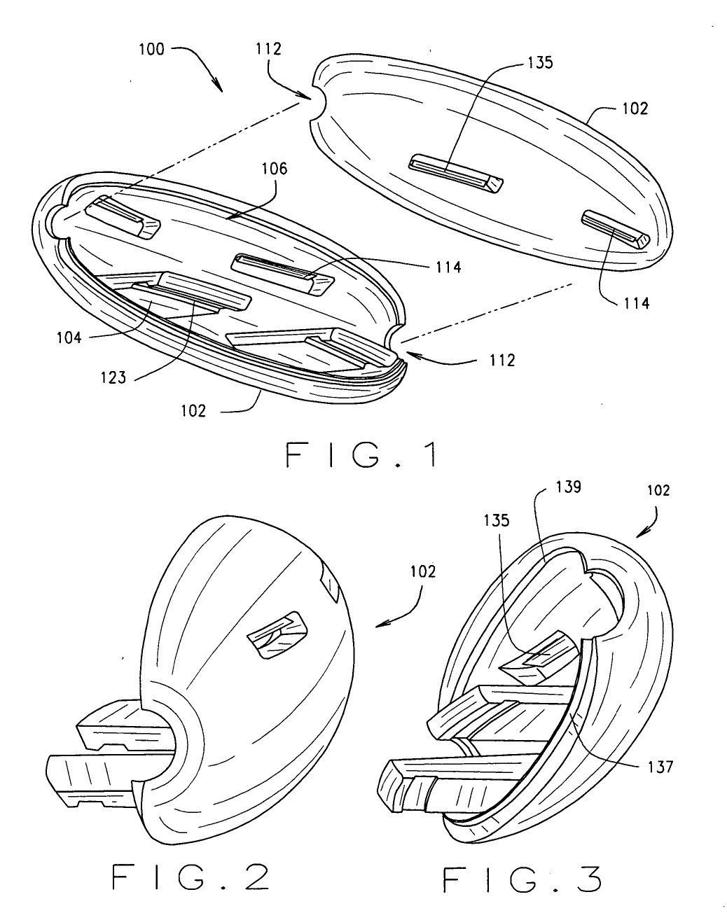

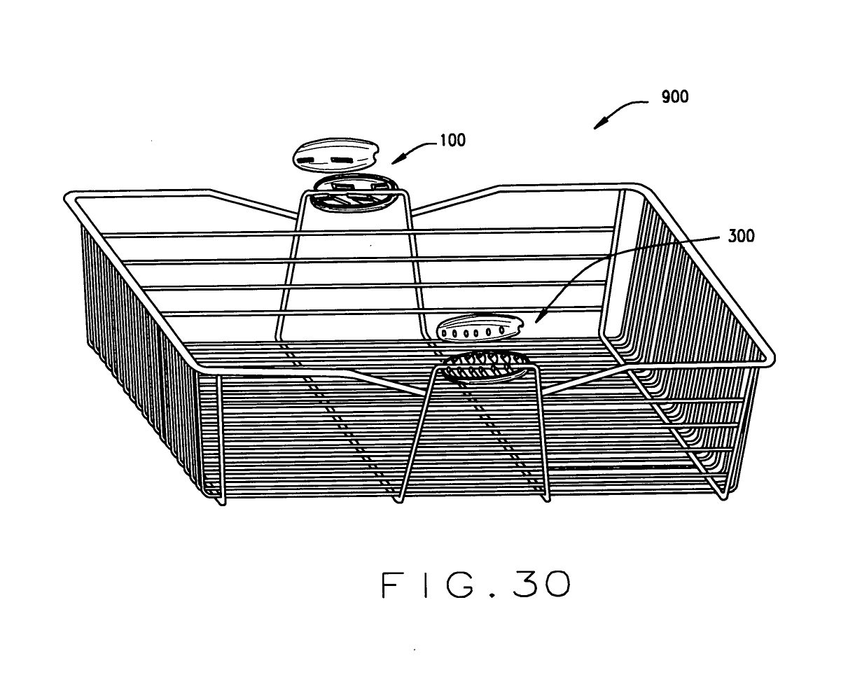

Referring now to FIGS. 1 through 5, there is shown one exemplary embodiment of a handle 100 according to the principles of the present invention. As shown, the handle 100 includes two handle pieces 102 configured to be engaged to another with a wire-like member therebetween. By way of example only, the handle 100 can be assembled to a wire handle portion of a wire basket (e.g., wire basket 900 in FIG. 30), wire bin, wire ventilated shelf, slide-type shelf or tray, among other suitable devices.

With continued reference to FIGS. 1 through 5, each handle piece 102 includes one or more portions 104 protruding or extending generally outwardly from an inner side 106 of the handle piece 102. The handle pieces 102 are configured to define a lengthwise passageway or opening 112 when the handle pieces 102 are assembled to one another, as shown in FIG. 5.

The handle pieces 102 further comprise one or more recesses or openings 114 configured to respectively receive the corresponding protruding portions 104 of the other handle piece 602. In this particular illustrated embodiment, each handle piece 102 includes two spaced-apart slots or receiving voids 114 and two tabs or key/tongue-shaped protrusions 104 that can be engagingly received within the recesses 114. This engagement of the protrusions 104 within the slots 114 can retain the respective handle pieces 102 to each other. Accordingly, in this particular embodiment shown in FIGS. 1 thorough 5, the engagement of the protrusions 104 within the recesses 114 retains the handle 100 in an assembled condition thereby operatively trapping a wire portion between the handle pieces 102 within the passage 112. Alternative embodiments include the handle pieces having more or less than two protruding portions and slots, and/or include handle pieces having differently configured protruding portions and slots, some of which are described and shown herein.

In some embodiments, at least one of the protruding portions/tabs or the receiving voids/slots may include at least one catch (e.g., rib, projection, protrusion, ridge, detent, dimple, ramp-ups, etc.). The other of the protruding portions and the slots may include at least one opening (e.g., recess, void, cavity, slot, groove, hole, depression, etc). This opening can be configured to engagingly receive the catch when the protruding portion is engaged within the slot. Accordingly, the engagement of the catch within the opening can inhibit the egress of the protruding portion from within the slot.

In the particular illustrated embodiment of FIGS. 1 through 5, the protruding portions 104 include grooves 123, and the slots 114 include ribs or ramp-ups 135. Each groove 123 is disposed along at least a portion of a tab 104, and each rib 135 is disposed along at least a portion of an inner surface defining a slot 114. The grooves 123 are configured to engagingly receive the ribs 135 when the protruding portions 104 are engaged within the slots 114. Engagement of the ribs 135 within the grooves 123 inhibits the egress of the protruding portions 104 from within the slots 114. Alternative embodiments include the tabs having male catch features, and the slots having the female catch feature for engagingly receiving the male catch features. Further embodiments include slots and protruding portions having male and female catch features, but which are located at different positions. Yet other embodiments do not include male and female catch features, such as catch 135 and opening 123.

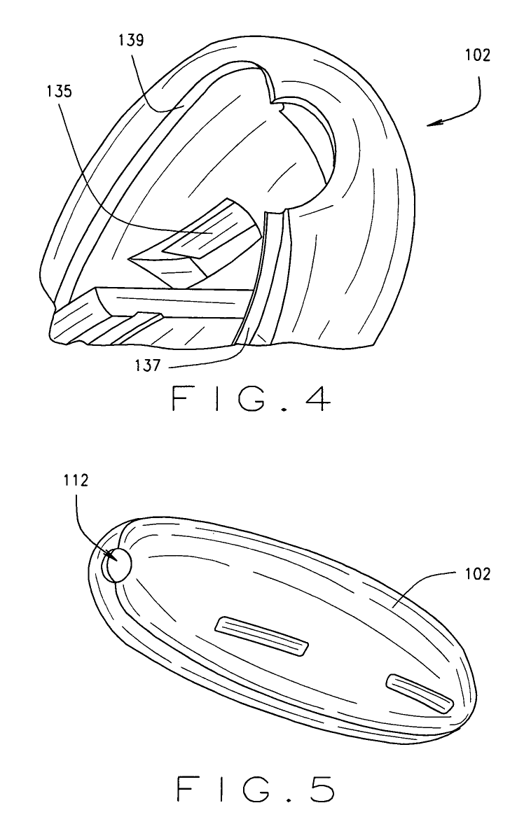

Also shown in FIGS. 1 and 4, various embodiments can include a protruding or male-type lip or edge portion 137 disposed at least partially along the portion of the handle piece 102 having the tabs 104. A receiving or female-type lip or edge portion 139 is shown disposed at least partially along the portion of the handle piece 102 having the receiving voids/slots 114. When the handle pieces 102 are assembled to one another as shown in FIG. 5, the engagement of the lip portions 137 and 139 can help retain the handle 100 in an assembled condition. Accordingly, in some embodiments, the handle 100 can thus be retained in an assembled condition by the engagement of the tabs 104 within the slots 114, the engagement of the ribs 135 within the grooves 123, and/or the engagement of the male-type lip portions 137 with the female-type lip portions 139.

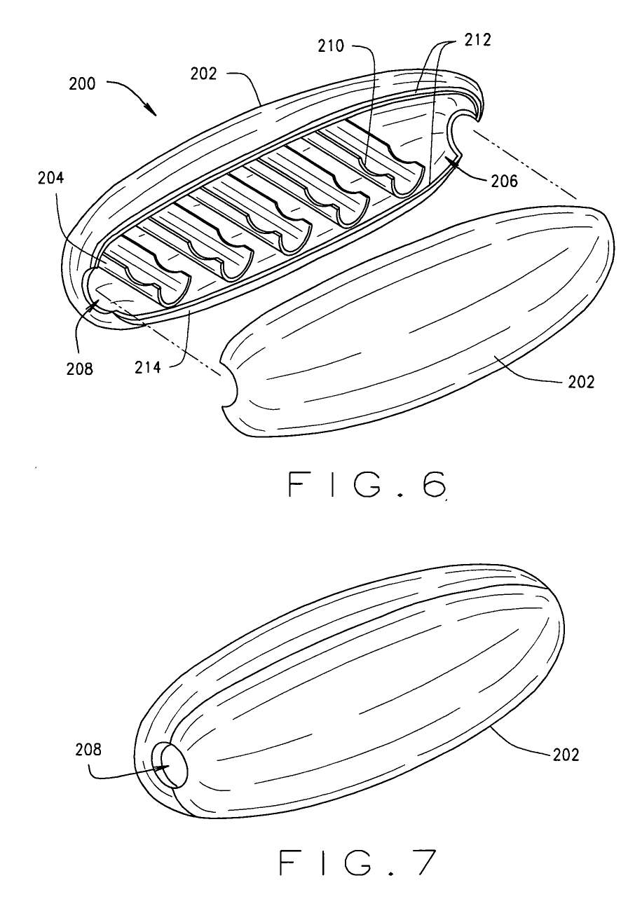

FIGS. 6 through 8 illustrate another exemplary embodiment of a handle 200. As shown, the handle 200 includes two handle pieces 202 configured to be engaged to another with a wire-like member therebetween. By way of example only, the handle 200 can be assembled to a wire handle portion of a wire basket (e.g., wire basket 900 in FIG. 30), wire bin, wire ventilated shelf, slide-type shelf or tray, among other suitable devices.

As shown, each handle piece 202 includes protruding portions 204 extending from an inner side 206 of the handle piece 202. The handle pieces 202 are configured to define a longitudinal passageway or opening 208 when the handle pieces 202 are assembled to one another. The handle pieces 202 when assembled can be retained over a portion of a wire member received within the longitudinal passage 208 by the one or more protruding portions 204.

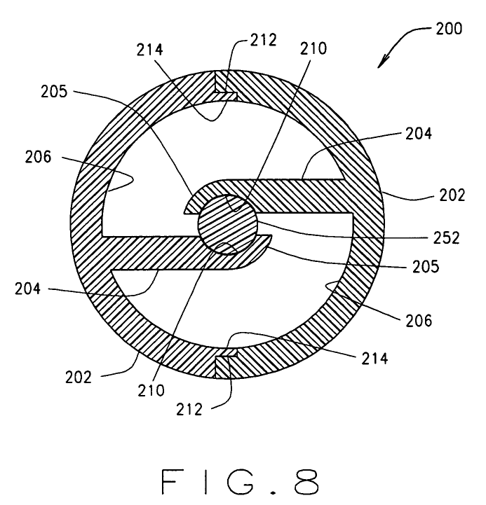

In this particular illustrated embodiment, the protruding portions 204 extend inwardly from the inner sides 206 of the handle pieces 202. The protruding portions 204 include a generally curved or arcuate channel or slot 210 adapted to receive therein a portion of a wire member (e.g., wire member 252 shown in FIG. 8). When a wire is positioned within the slots 210 and the handle pieces 202 are assembled to one another, the end portions 205 of the protruding portions 204 are disposed generally around (e.g., “over center”) the wire portion 252 within the slots 210.

As shown in FIGS. 6 and 8, the inner side 206 of each handle piece 202 further comprises lip or edge portions 212 and 214 disposed along the periphery of the handle piece 202. The lip or edge portions 212 and 214 of one handle piece 202 are configured to engage the corresponding lip or edge portion 212 and 214 of the other handle piece 202. The handle pieces 202 are adapted to be positioned generally about a portion of wire, with the protruding portions 204 slid over the portion of a wire towards the other handle piece 202.

Accordingly, in some embodiments, the handle 200 can thus be retained in an assembled condition about a portion of wire by the engagement of the end portions 205 of the protruding portions 204 with the wire portion within the slots 210 and/or the engagement of the lip portions 212, 214. In various embodiments, the protruding portions 204 of one handle piece 202 may be configured such that they do not contact or engage the other handle piece 202, but rather engage a portion of the wire member received between the two handle pieces 202. The engagement of the lip or edge portions 212 of the handle pieces 202 can limit movement of one handle piece 202 relative to (e.g., upwards or downwards in FIG. 8) the other handle piece 202 and the wire member 252. The engagement of the wire member 252 within the slots 210 in the protruding portions 204 can restrict the movement of one handle piece 202 away (e.g., left or right in FIG. 8) from the other handle piece 202.

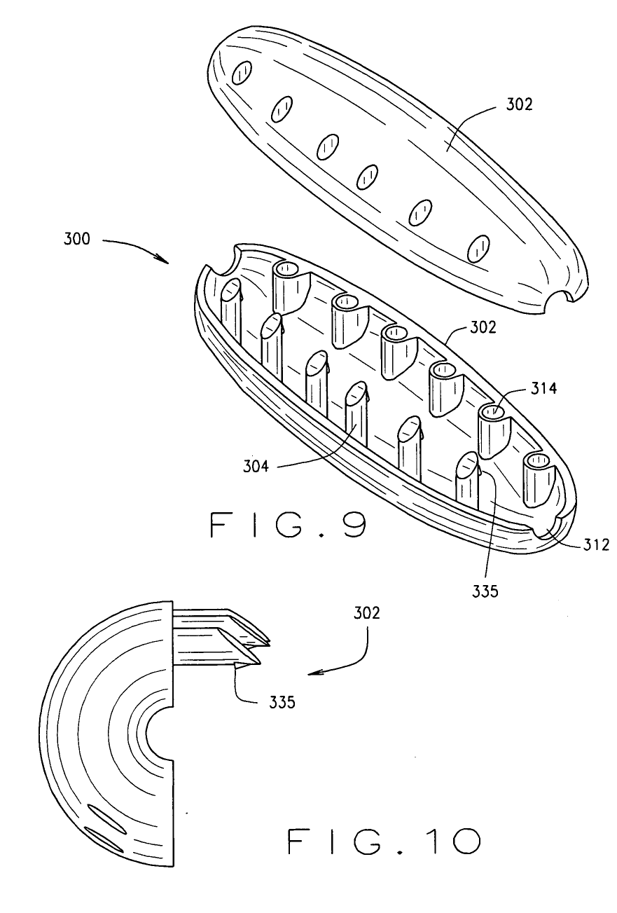

FIGS. 9 through 12 illustrate another exemplary embodiment of a handle 300 having two handle pieces 302. As shown, each handle piece 302 includes a plurality of projections or pins 304 and a plurality of openings or receiving voids 314. The pins 304 on one handle piece 302 are configured to be engagingly received within the openings 314 of the other handle piece 302. In this particular embodiment, each handle piece 302 includes six pins or posts 304 and openings 314 with generally circular transverse profiles. Alternative embodiment include handle pieces having more or less than six pins and openings and/or handle pieces having pins and openings with non-circular transverse profiles or cross-sections.

As shown in FIG. 12, the handle pieces 302 cooperatively define a longitudinal channel 312 extending therethrough. The handle pieces 302 are adapted to operatively trap a portion of a wire member received within the channel 312, with the pins 304 on each handle piece 302 being engagingly received within the openings 314 of the other handle piece 302.

In some embodiments, at least one of pin or receiving void/opening may include at least one male catch (e.g., rib, projection, protrusion, ridge, detent, dimple, ramp-ups, etc.) configured for engagement with at least one female catch feature (e.g., opening, recess, void, cavity, slot, groove, hole, depression, etc) defined by the other of the pin or receiving void/opening. This female catch feature or opening can be configured to engagingly receive the male catch when the pin is engaged within the receiving void. Accordingly, the engagement of the male catch within the female catch feature can inhibit the egress of the pin from the receiving void.

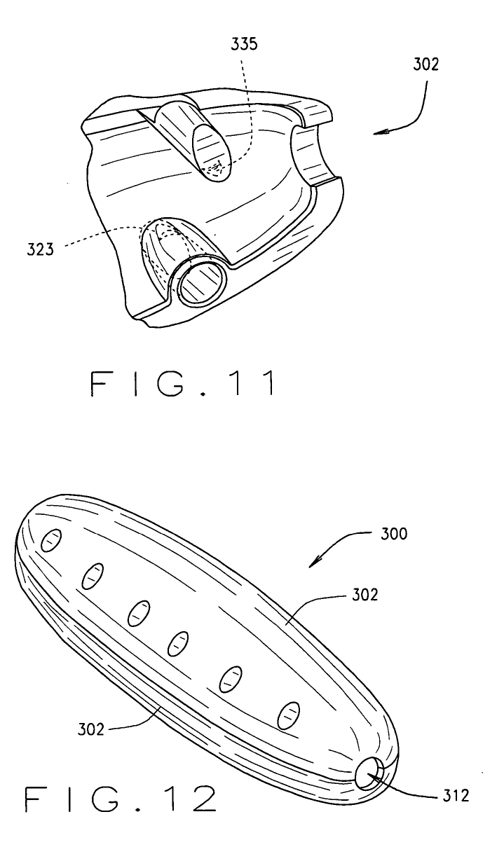

In the particular illustrated embodiment of FIGS. 9 through 11, the pins 104 include male catches 335 (e.g., rib, projection, protrusion, ridge, detent, dimple, ramp-ups, etc.), and the receiving voids or openings 314 include female catch features 323 (FIG. 11) (e.g., opening, recess, void, cavity, slot, groove, hole, depression, etc). The female catch features 323 are configured to engagingly receive the male catches 335 when the pins 304 are engaged within the receiving voids/openings 314. Engagement of the male catches 335 within the female catch features 323 inhibits the egress of the pins 304 from within the receiving voids/openings 314. Alternative embodiments include the pins having female catch features, and the receiving voids having male catches. Further embodiments include the pins and receiving voids having male and female catch features, but which are located at different positions. Yet other embodiments do not include the male and female catch features, such as catch 335 and opening 323.

In some embodiments, the pins can include tapered or angled end portions. This tapering or angling can help or facilitate insertion of the pins into the corresponding recesses. Alternative embodiments include one or more pins without tapered or angled end portions.

In various embodiments, the pins 304 and the handle piece 302 can be integrally or monolithically formed as a single component. One exemplary implementation integrally molds the handle piece 302 and the pins 304 as a single component. Even though the pins 304 can be formed integrally with the handle piece 302, such is not required. In other embodiments, the pins may comprise discrete components that are separately engaged to the handle piece 302, for example, by press fitting, welding, threads, among other suitable methods.

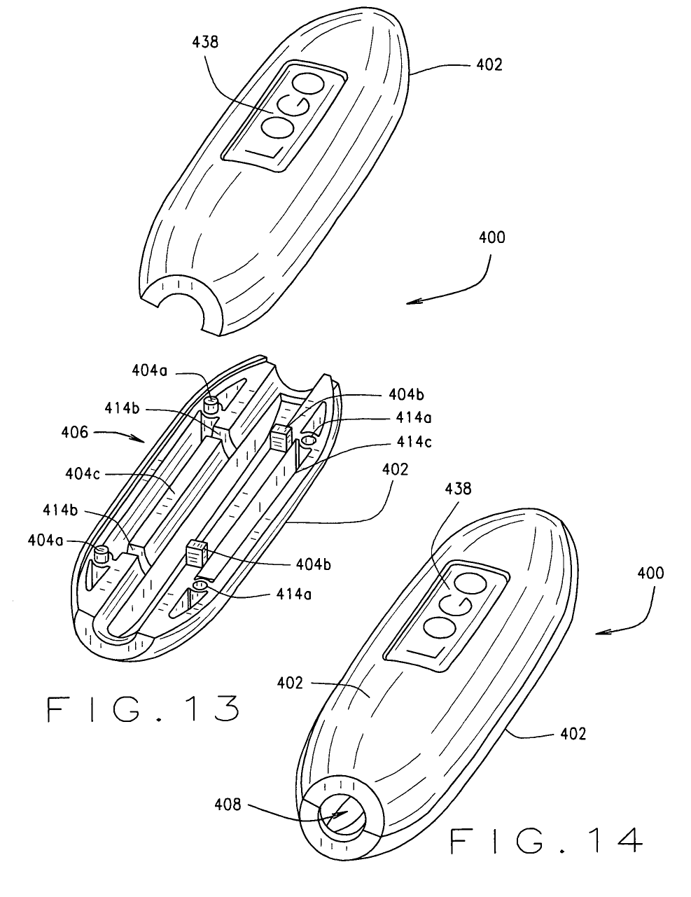

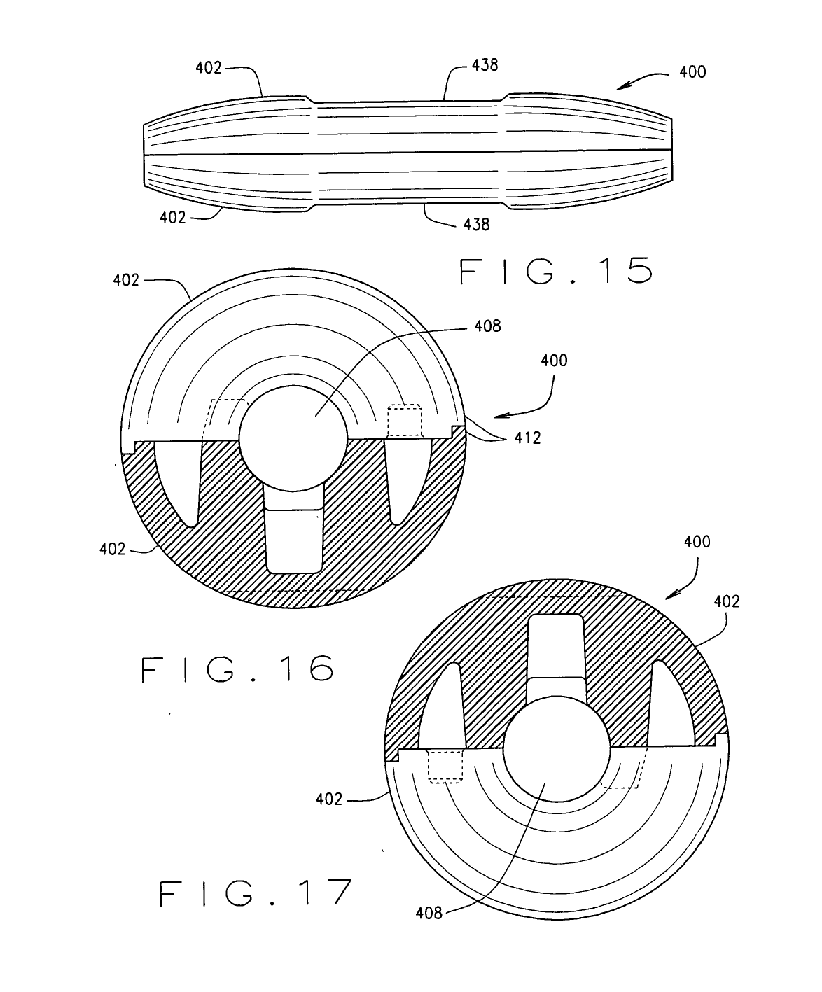

FIGS. 13 through 17 illustrate another exemplary embodiment of a handle 400. As shown, the handle 400 includes two handle pieces 402 configured to be engaged to another with a wire-like member therebetween. As shown in FIG. 13, each handle piece 402 includes protruding portions 404 extending from an inner side 406 of the handle piece 402. Each handle piece 402 also includes receiving voids/openings 414 for engagingly receiving the corresponding protruding portions 404 of the other handle piece 402. As shown in FIG. 14, the handle pieces 402 are configured to define a longitudinal passageway or opening 408 when the handle pieces 402 are assembled to one another. The handle pieces 402 when assembled to one another can be retained over a portion of a wire member received within the longitudinal passage 408 by the engagement of the protruding portions 404 within the corresponding receiving voids/openings 414.

In the particular illustrated embodiment of FIG. 13, the protruding portions 404 comprise pins 404a having a circular transverse profile or cross-section, rectangular projections 404b, and tabs 404c extending outwardly from the inner sides 406 of the handle pieces 402. The corresponding or receiving voids/openings 414 comprise circular openings 414a and recesses 414b and 414c for engagingly receiving the corresponding protruding portions 404 of the other handle piece 402. As shown in FIG. 16 and 17, the tabs 404c are configured to have a curved surface portion with a curvature complementary to a curvature of an outer surface portion of the wire-like member. Accordingly, the tabs 404c can thus disposed at least partially around a wire within the passage 408 when the handle pieces 402 are assembled to one another. Alternative embodiments can include different combinations of and/or differently arranged/configured protruding portions and receiving voids that what are shown in the figures.

With continued reference to FIGS. 16 and 17, the handle pieces 402 can include lip or edge portions 412 disposed along the outer periphery of the handle piece 402. The lip or edge portions 412 of one handle piece 402 are configured to engage the corresponding lip or edge portions 412 of the other handle piece 402. Accordingly, the engagement of the lip portions 412 can create a wedging effect when the handle pieces 402 are fitted about or clamped around a wire. This wedging effect created by the engagement of the lip portions 412 of one handle piece 402 with the lip portions 412 of the other handle piece 402 can thus help retain the handle 400 in an assembled condition.

Accordingly, in some embodiments, the handle 400 can thus be retained in an assembled condition about a portion of wire by the engagement of the pins 404a within the corresponding recesses 414a, engagement of the rectangular projections 404b within the corresponding recesses 414b, the positioning of the “over center” tabs 404c generally about at least a portion of the wire member, and/or the wedging effect created by the engagement of the lip portions 412 of one handle piece 402 with the lip portions 412 of the other handle piece 402.

In addition, movement of one handle piece 402 relative to (e.g., left or right in FIGS. 16 and 17) the other handle piece 402 can be inhibited by the engagement of the lip or edge portions 412 of the handle pieces 402, the engagement of the “over center” tabs 404c with the wire member, and the engagement of the pins 404a and projections 404b with the corresponding recesses 414a and 414b. Movement of one handle piece 402 away (e.g., upwards or downwards in FIGS. 16 and 17) from the other handle piece 402 can be inhibited by the engagement of the “over center” tabs 404c with the wire member and the engagement of the pins 404a and projections 404b with the corresponding recesses 414a and 414b.

In various embodiments, either or both handle pieces 402 can include a relatively flat outer surface portion 438 that includes indicia thereon, such as one or more advertisements, trademarks, trade names, service marks, graphic images, graphic elements, designs, artwork, distinctive marks, identifying symbols, company logos, company contact information, text, alphanumeric characters, sports team insignias, names, monograms, photographs, among others.

In some embodiments, the outer surface portion 438 may include integrally formed (e.g., integrally molded, etched, carved, etc.) indicia thereon. Alternatively, the outer surface portion 438 may simply provide an area that is conducive for printing and/or adhesively affixing a label thereto.

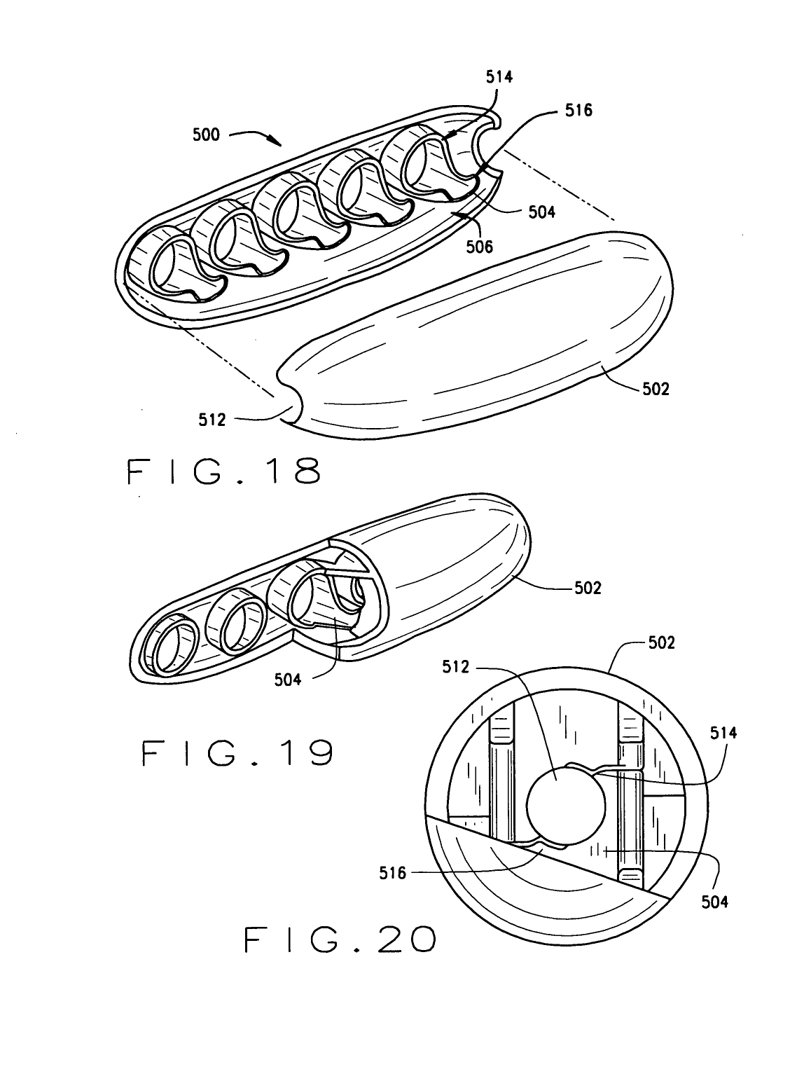

FIGS. 18 through 20 illustrate another exemplary embodiment of a handle 500 having two handle pieces 502. As shown, each handle piece 502 includes one or more portions 504 protruding or extending outwardly from an inner side 506 of the handle piece 502. The handle pieces 502 are configured to define a passage or opening 512 when the handle pieces 502 are assembled to one another, as shown in FIG. 20. When assembled to one another, the engagement of the protruding portions 504 can help retain the handle pieces 502 assembled to one another.

In this particular embodiment, the protruding portions 504 include recessed portions 514 and key portions 516. The key portions 516 on each handle piece 502 are configured to respectively engage corresponding recessed portions 514 of the other handle piece 502. In the embodiment shown in FIGS. 18 through 20, each handle piece 502 includes five spaced-apart protruding portions 504 that cooperate with the five spaced-apart protruding portions 504 of the other handle piece 502 to define the passage or opening 512. Alternative embodiments include more or less than five protruding portions and/or include differently configured protruding portions, some of which are described and shown herein.

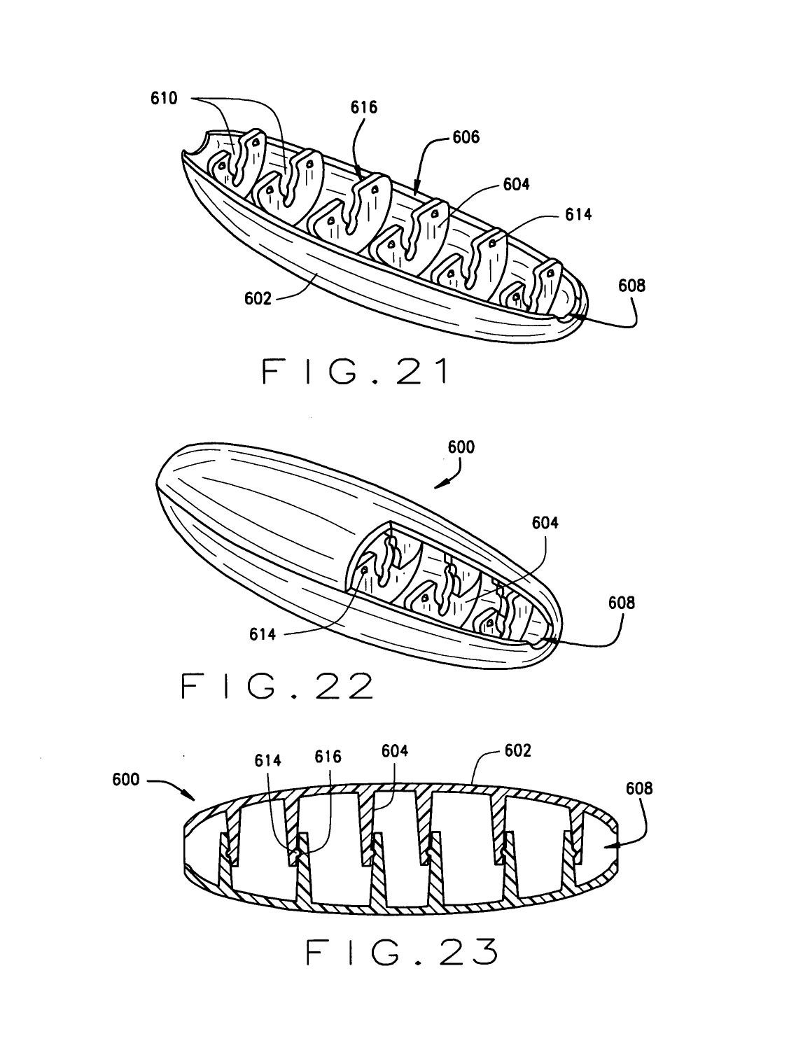

FIGS. 21 through 23 illustrate another exemplary embodiment of a handle 600 having two handle pieces 602. As shown, each handle piece 602 includes protruding portions 604 extending from an inner side 606 of the handle piece 602. The handle pieces 602 are configured to define a longitudinal passage or opening 608 when the handle pieces 602 are assembled to one another. The handle pieces 602 when assembled to one another are adapted to be retained over a portion of wire received within the opening 608.

In this particular embodiment, the protruding portions or ribs 604 include slots 610 adapted to receive a portion of wire therein. The protruding portions 604 have detents or protuberances 614 and corresponding recesses or dimples 616. The detents 614 associated with one handle piece 602 are configured to be engagingly received within the dimples 616 of the other handle piece 602, to thereby retain the handle pieces 602 assembled to one another. When assembled to one another in this exemplary manner, the handle pieces 602 can operatively trap a wire portion therebetween.

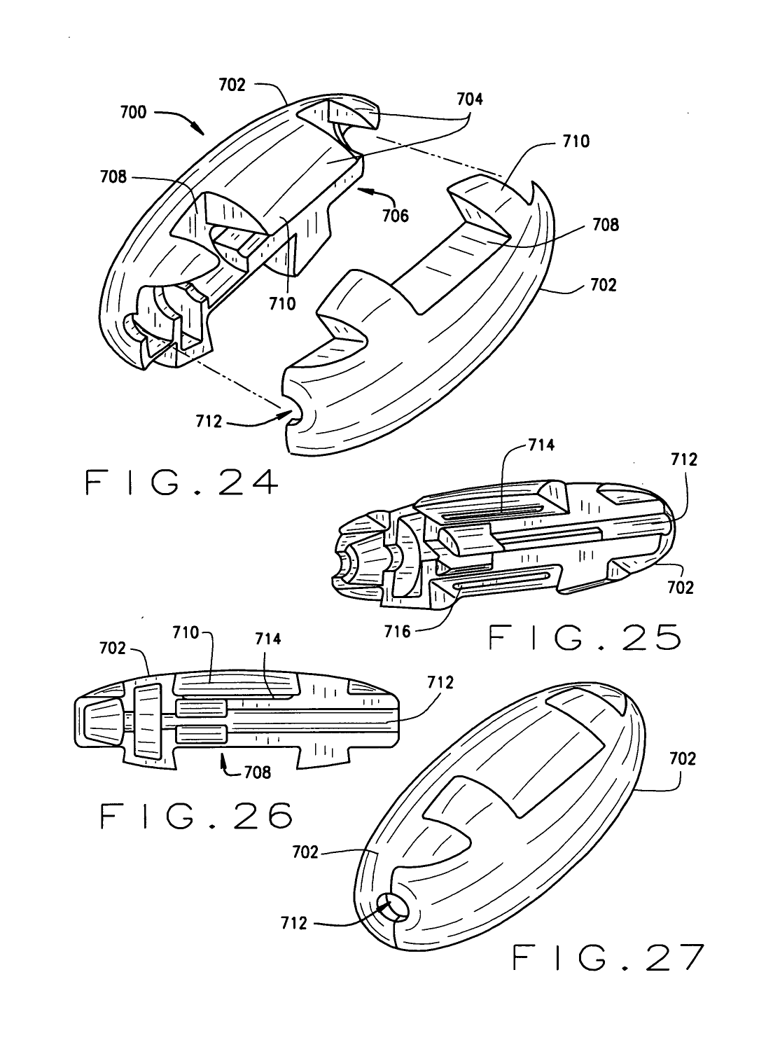

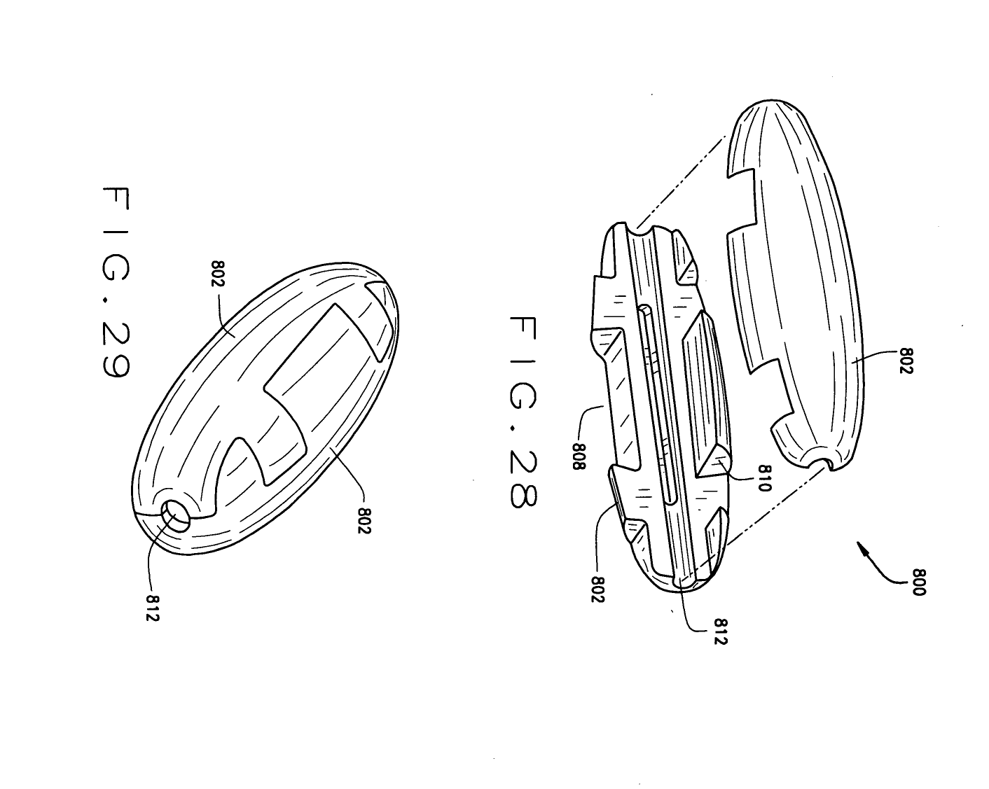

FIGS. 24 through 27 illustrate another embodiment of a handle 700 having two handle pieces 702. Each handle piece 702 includes one or more protruding portions 704 extending from an inner side 706 of the handle piece 702. As shown in FIG. 27, the handle pieces 702 are configured to define a passageway or opening 712 when the handle pieces 702 are assembled to one another. When so assembled, the handle pieces 702 can be retained over a portion of wire received within the opening 712.

In this particular embodiment, the protruding portions 704 generally comprise interlocking portions configured to interlock and retain the two handle pieces 702 assembled to one another. The handle pieces 702 include a channel 712 for receiving a portion of a wire therein. Each handle piece 702 includes at least one recessed interlocking portion 708, and at least one protruding interlocking portion 710. The protruding interlocking portion 710 is configured to align with and be received in the corresponding recessed interlocking portion 708.

As shown in FIG. 25, the protruding interlocking portion 710 has at least one detent member or rib 714 that is configured to be engagingly received within at least one groove 716 of the recessed interlocking portion 708 of the other handle piece 702. The two handle pieces 702 are adapted to operatively trap a portion of wire therebetween. The engagement of the detent member or rib 714 within the grove 716 retains the two handle pieces 702 assembled to one another. Alternative embodiments can include handle pieces that do not include the detent members or ribs 714 or the grooves 716. Still yet other embodiments can include ribs and corresponding grooves arranged differently that what is shown in the figures.

FIGS. 28 and 29 illustrate another exemplary embodiment of a handle 800 having two handle pieces 802. As shown in FIG. 29, the handle pieces 802 are configured to cooperatively define a passageway or opening 812 therebetween when the handle pieces 802 are assembled to one another. When so assembled, the handle pieces 802 can be retained over a portion of wire received within the passage 812.

Continuing with this particular illustrative embodiment, each handle piece 802 includes at least one recessed interlocking portion 808 configured to be frictionally engaged within (and thus interlock) with at least one protruding interlocking portion 810 of the other handle piece 802. Accordingly, the engagement of the interlocking members 808 and 810 can thus retain the two handle pieces 802 assembled to one another such that the two handle pieces 802 can operatively trap a portion of wire within the passage 812.

FIG. 30 illustrates an exemplary wire basket 900 about to be provided with a handle 100 (shown in FIGS. 1 through 5) and a handle 300 (shown in FIGS. 9 through 12). The particular wire basket 900 shown in FIG. 30, however, is for purposes of illustration only as various aspects of the invention can be used with a wide range of wires, wire-like members, and devices having such wires or wire-like members, including wire ventilated shelves, bins, baskets, sliding storage devices (e.g., sliding shelves, trays, etc.), kitchen cabinetry, garage cabinetry, bathroom cabinetry, pots, pans, buckets, among other containers and storage devices. Accordingly, the specific references to wire and to wire basket herein should not be construed as limiting the scope of the invention to only one specific form/type of application. By way of example, one or more handles of the present invention may be used in connection with a slide-type of installation in which the handles allow the user to more comfortably pull out the sliding device, such as in kitchen, garage, and/or bathroom cabinetry.

Further, the particular methods of manufacture and geometries disclosed herein are exemplary in nature and are not to be considered limiting. The steps, processes, and operations described herein are not to be construed as necessarily requiring their performance in the particular order discussed or illustrated, unless specifically identified as an order or performance. It is also to be understood that additional or alternative steps may be employed. In addition, any one or more aspects of the invention may be implemented individually or in any combination with any one or more of the other aspects of the invention.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present invention and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A handle for attachment to a wire-like member, the handle comprising at least two handle pieces, each said handle piece having an outer side, an inner side, at least one portion protruding from the inner side thereof, and at least one recess for engagingly receiving the at least one protruding portion of the other said handle piece, at least one of said protruding portions and recesses including at least one catch engageable within at least one opening defined by the corresponding other protruding portion or recess for inhibiting the egress of the protruding portion from within the recess, the handle pieces, when assembled to one another with the protruding portions engaged within the recesses, cooperatively forming a handle body outer surface and a passage therethrough for receiving at least a portion of the wire-like member, whereby the engagement of the protruding portions within the recesses inhibits relative movement between the handle pieces to thereby attach the handle to the portion of the wire-like member within the passage.

2. The handle of claim 1, wherein each said protruding portion includes at least one catch, and wherein each said recess includes at least one opening configured to engagingly receive the catch of the corresponding protruding portion.

3. The handle of claim 2, wherein the at least one protruding portion of each said handle piece comprises a plurality of pins each having at least one catch, and wherein the at least one recess of each said handle piece comprises a plurality of corresponding recesses each having at least one opening for engagingly receiving the at least one catch of the corresponding pin.

4. The handle of claim 1, wherein each said recess includes at least one catch, and wherein each said protruding portion includes at least one opening configured to engagingly receive the catch of the corresponding recess.

5. The handle of claim 4, wherein the at least one catch includes at least one rib disposed along at least a portion of an inner surface at least partially defining the at least one recess, and wherein the at least one opening includes at least one groove disposed along at least a portion of the at least one protruding portion for engagingly receiving the at least one rib of the corresponding protruding portion.

6. The handle of claim 5, wherein the at least one protruding portion of each said handle piece comprises at least one substantially rectangular tab, and wherein the at least one recess of each said handle piece comprises at least one substantially rectangular slot defined through the handle piece.

7. The handle of claim 1, wherein the at least one protruding portion of each said handle piece comprises at least one pin, and wherein the at least one recess of each said handle piece comprises at least one corresponding recess for engagingly receiving the at least one pin of the other said handle piece.

8. The handle of claim 1, wherein each said handle piece includes a lip portion disposed at least partially along a periphery thereof and configured to engage a corresponding lip portion of the other said handle piece, whereby engagement of the lip portions inhibits relative movement between the handle pieces.

9. The handle of claim 1, wherein the outer side of at least one said handle pieces includes a substantially flat outer surface portion configured for displaying indicia thereon.

10. A handle for attachment to a wire-like member, the handle comprising at least two handle pieces, each said handle piece having an outer side, an inner side, at least one pin protruding from the inner side thereof, and at least one recess for engagingly receiving the at least one pin of the other said handle piece, at least one of said pins having a substantially circular transverse profile, at least one of said recesses having a corresponding substantially circular transverse profile, the handle pieces, when assembled to one another with the pins engaged within the recesses, cooperatively forming a handle body outer surface and a passage therethrough for receiving at least a portion of the wire-like member, whereby the engagement of the pins within the recesses inhibits relative movement between the handle pieces to thereby attach the handle to the portion of the wire-like member within the passage.

11. The handle of claim 10, wherein at least one of said pins includes a tapered end portion configured to facilitate insertion of the tapered end portion within the corresponding recess.

12. The handle of claim 10, wherein each said pin includes at least one catch, and wherein each said recess includes at least one opening configured to engagingly receive the at least one catch of the corresponding pin, whereby engagement of the catches within the openings inhibits the egress of the pins from within the recesses.

13. The handle of claim 10, wherein at least one of said pins and said recesses includes at least one catch engageable within at least one opening defined by the corresponding pin or recess when the pin is engaged within the recess, whereby engagement of the at least one catch within the at least one opening inhibits the egress of the pin from within the recess.

14. The handle of claim 10, wherein each said handle piece includes at least one portion protruding from the inner side and configured such that, when the handle pieces are assembled to one another with the wire-like member within the passage, the at least one protruding portion of one said handle piece is disposed generally about a first side portion of the wire-like member and the at least one protruding portion of the other said handle piece is disposed generally about a second side portion of the wire-like member generally opposite the first side portion, whereby the protruding portions cooperatively inhibit relative movement between the handle pieces through contact with the wire-like member.

15. The handle of claim 10, wherein each said handle piece includes a lip portion disposed at least partially along a periphery thereof and configured to engage a corresponding lip portion of the other said handle piece, whereby engagement of the lip portions inhibits relative movement between the handle pieces.

16. The handle of claim 10, wherein each said handle piece includes at least two pins, and at least two recesses disposed relative to the handle piece's longitudinal centerline axis on a side thereof generally opposite that of the at least two pins.

17. The handle of claim 10, wherein each said handle piece includes at least one pin having a substantially circular transverse profile, and at least one pin having a non-circular transverse profile.

18. The handle of claim 17, wherein the at least one pin having the substantially circular transverse profile is disposed relative to the handle piece's longitudinal centerline axis on a side thereof generally opposite that of the at least one pin having the non-circular transverse profile.

19. The handle of claim 10, wherein at least one of said pins has a substantially rectangular transverse profile.

20. The handle of claim 10, wherein each said handle piece includes at least two pins having substantially circular transverse profiles, at least two pins having non-circular transverse profiles disposed relative to the handle piece's longitudinal centerline axis on a side thereof generally opposite that of the at least two pins having substantially circular transverse profiles, and at least four corresponding recesses for receiving the pins of the other said handle piece.

21. A handle for attachment to a wire-like member, the handle comprising at least two handle pieces, each said handle piece having an outer side, an inner side, and at least one portion protruding from the inner side thereof, the handle pieces, when assembled to one another, cooperatively forming a handle body outer surface and a passage therethrough for receiving at least a portion of the wire-like member, the protruding portions configured such that, when the handle pieces are assembled to one another with the wire-like member within the passage, the at least one protruding portion of one said handle piece is disposed generally about a first side portion of the wire-like member and the at least one protruding portion of the other said handle piece is disposed generally about a second side portion of the wire-like member generally opposite the first side portion, whereby the protruding portions cooperatively inhibit relative movement between the handle pieces through contact with the wire-like member.

22. The handle of claim 21, wherein the at least one protruding portion includes at least one groove for receiving therein a portion of the wire-like member therein.

23. The handle of claim 21, wherein the at least one protruding portion includes a plurality of protruding portions defining grooves for receiving therein portions of the wire-like member therein, each groove of one of the handle pieces being longitudinally aligned with the other grooves of that handle piece.

24. The handle of claim 21, wherein the at least one protruding portion includes an end portion having a substantially u-shaped transverse profile.

25. The handle of claim 21, wherein the at least one protruding portion includes a curved surface portion having a curvature complementary to a curvature of an outer surface portion of the wire-like member.
